(19) United States
(12) Patent Application Publication
(10) Pub. No.: US 2006/0201898 A1
(43) Pub. Date: Sep. 14, 2006

(54) Expandable paintball gun rack

(76) Inventor: Russ Hughes, Sun City, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/360,551

(22) Filed: Feb. 22, 2006

Related U.S. Application Data
(60) Provisional application No. 60/654,790, filed on Feb. 22, 2005.

(51) Int. Cl. B60R 7/14

(52) U.S. Cl. 211/64; 42/94

(57) ABSTRACT

A paintball gun holder is disclosed that allows for one or multiple paintball guns to be held prior to or after competition. The holder can be mounted on a stand, wall or table. The holder is easily transportable and can be broken down into pieces for still easer transportation and storage. The holder consists of two “U” shaped cradles that hold the barrel and the tank or stock of the gun. The basic paintball gun holder can be expandable to accommodate various numbers of paintball guns to accommodate larger or smaller groups of players.

### CROSS REFERENCE TO RELATED APPLICATION

This application claims priority to provisional application Ser. No. 60/654,790 filed Feb. 22, 2005.

### FIELD OF THE INVENTION

This invention relates to new and useful improvements in apparatus for storing and holding paintball guns. More particularly, the present invention relates to a holder for paintball guns where one or multiple guns can be held without damaging the guns. The apparatus is versatile enough to operate as a stand-alone device, wall mount or table.

### BACKGROUND OF THE INVENTION

Simulated combat has become more popular with the invention of paintball guns. The paintball gun consists of a gun type device that uses compressed air, carbon dioxide or similar compressed gas to shoot paint balls. When the paint balls make contact with an object or person the paint ball breaks open and marks the object or person with the paint. When the person is substantially marked with paint they must stop playing since they have essentially been killed on the playing field.

The guns that are used in the game can cost several hundred dollars or more. Prior to and after playing the game the guns may be set onto the ground or other surface. It is possible that dirt bugs or water can enter the guns and cause damage to them. To reduce or eliminate damage to the paintball guns an apparatus needs to be made that allows storage of the guns to keep them off of the ground and reduce the possibility of damaging the gun(s). The ideal device would also allow for the storage and holding of one or multiple guns.

The prior art discloses many examples of apparatus to aid in the holding of paintball and other types of guns, but none providing the combination of features disclosed and claimed herein.

U.S. Pat. No. 6,367,466 issued Apr. 9, 2002 to Nettles, Jr. discloses a paint gun cradle for supporting a paintball gun on a table. This invention satisfied the ability of keeping the paintball gun in an upright orientation, but it is intended only for use on a table. The invention also is only configured table used with a single paintball gun. This invention is required to be used on table because the invention only provides support for the barrel of the gun, and the table provides support for the tank.

U.S. Pat. No. 5,875,580 issued Mar. 2, 1999 to Hill et al. discloses a rifle rest for use with a rifle or other similar firearm. The rifle rest comprises and an “X” shaped structure with a pad that rests inside the structure. Due to the shape of the invention, the invention is only intended for use with a single gun. While this invention satisfies the ability to support a gun it is not intended for use with multiple guns or for use with a paintball gun.

U.S. Pat. No. 5,666,757 issued Sep. 16, 1997 to Helmstadter discloses a combination pistol and rifle shooting rest. The rest is configured to be driven into the ground and provides a secure structure to allow it easier sighting of the weapon. Due to the shape of the invention, the invention is only intended for use with a single gun. While this invention satisfies the ability to support a gun it is not intended for use with multiple guns or for use with a paintball gun.

U.S. Pat. No. 4,873,777 issued Oct. 17, 1989 to Southard discloses a press fit in gun cradle for fire our maintenance and repair. This invention is intended for use with the maintenance and repairs a firearm. While this invention can be used to hold a paintball gun it is not configured for use with a paintball gun or for use with multiple paintball guns. It is further intended for use only on a table or similar flat surface.

U.S. Pat. No. 4,449,314 issued May 22, 1984 to Sorenson discloses a fire our support. The invention is intended for use to display, clean and sight a gun. While this invention can be used to hold a paintball gun it is only intended for use with a single gun and is also only configured for use with a table or similar flat surface.

U.S. Pat. No. 3,827,172 issued Aug. 6, 1974 to Howe discloses a bench rest device for firearms. The invention is primarily used to allow a support for the gun to enable the shoot to more accurately fire the gun. While this invention can be used to hold a paintball gun it is not configured for use with a paintball gun or for use with multiple paintball guns. It is further intended for use only on a table or similar flat surface.

Other prior art inventions are available for use in the storing and/or displaying of multiple firearms. Examples of these prior art inventions are gun racks that can be mounted in a car or truck, and gun racks that are often found in safes, police stations or gun stores were the guns are secured and held for easy access. These devices provide the support for multiple guns but are not intended for paintball guns, nor are they configured for use in the field and are not expandable to accommodate more or less than intended number of gun holding positions.

What is needed it is a simple to erect and set-up and expand holder for one or more paintball guns where both the barrel and tank are supported. The ideal device would also provide expandability to accept more guns, and be configurable for use on a wall or table. The proposed device satisfies these needs.

### BRIEF SUMMARY OF THE INVENTION

The present invention relates to holding apparatus for one or multiple people guns. The apparatus is easily configured for placement on the ground and can also be mounted on a wall or rest on a table.

One of the objects of this invention is to provide a simple to erect multiple paintball gun holding and/or storage device that allows multiple users to safely store their guns without damage.

Another object of the invention is to provide support for the paintball guns were both the barrel and tank are both supported.

Another object of the invention is to provide an expandable paintball gun holding apparatus they can easily be configured to hold more or less paintball guns.

Another object of the invention is to provide that the paintball gun holding apparatus will also allow mounting on a wall or vertical surface.

Another object of the invention is to provide a paintball gun holding apparatus that will support the paintball gun when the paintball gun rests on a table or similar flat surface.

Still another object of the invention is to provide a multiple paintball gun holding apparatus that can be easily broken down for transportation or storage.

Still another object of the invention is to provide easy and simple adjust ability to accommodate paintball guns of various shapes and sizes.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view of the gun rack.

FIG. 2 is an isometric view of a single holder with a paintball gun installed on the holder.

FIG. 3 is a front view of the barrel holding portion of the holder.

FIG. 4 is a front view of the tank holding portion of the holder.

FIG. 5 is an alternate isometric view of the paintball gun holder shown above a wall mountable adapter.

FIG. 6 is an alternate isometric view of the paintball gun holder shown above a table mountable adapter.

### DETAILED DESCRIPTION

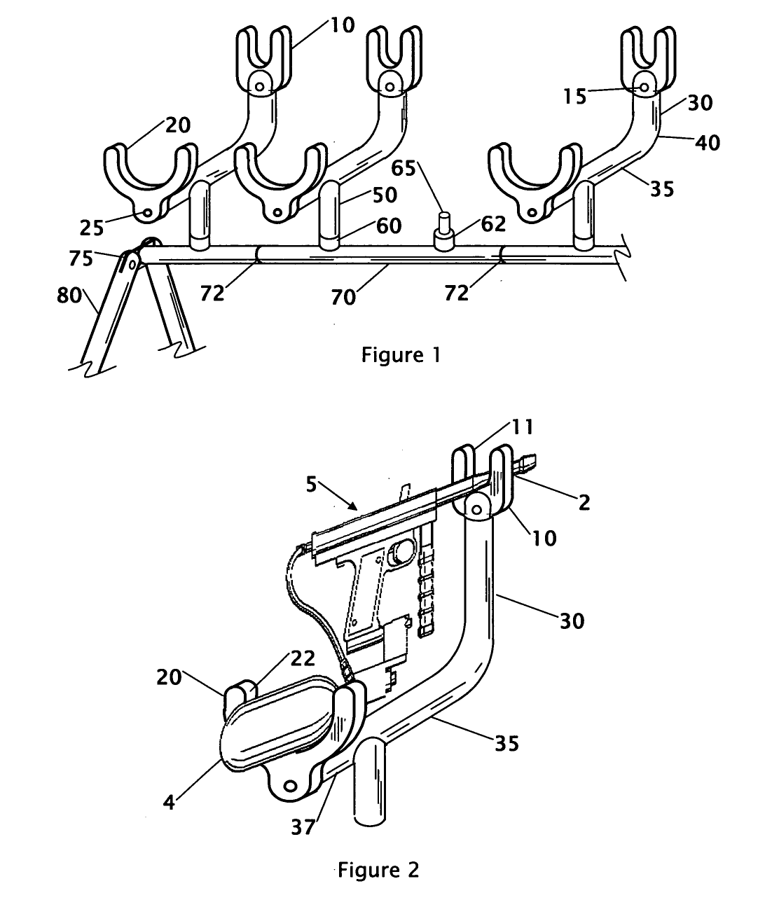

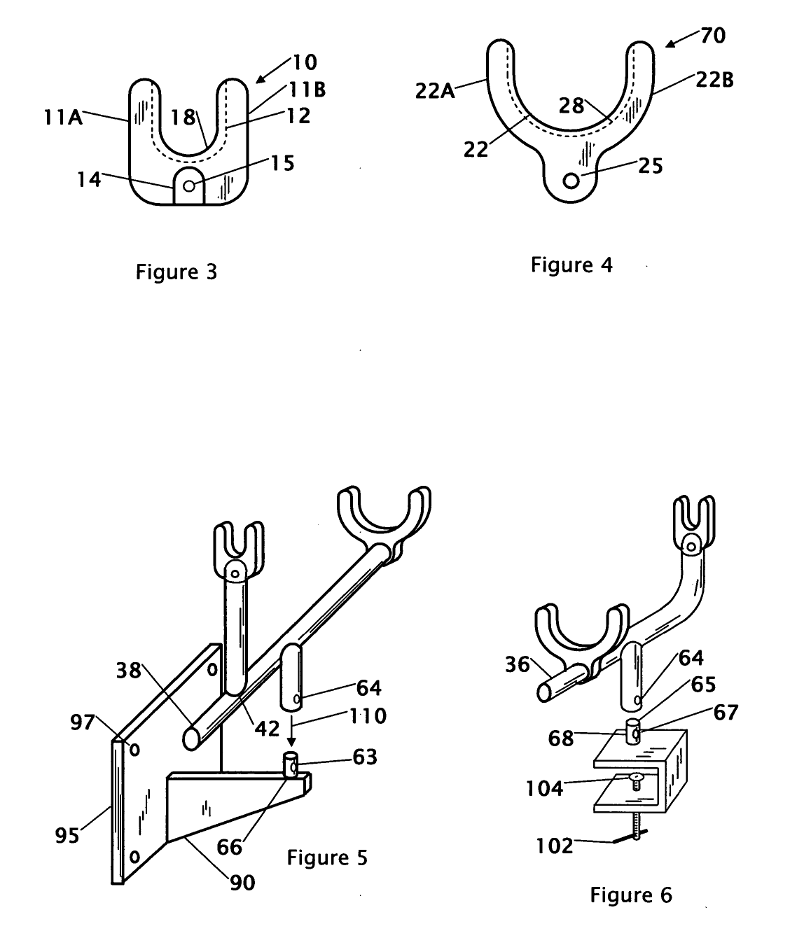

Referring to FIG. 1, there is shown an isometric view of the gun rack. The gun consists of a tubular member with a resting location for the barrel of the gun 10 and a separate resting location for the compressed air or Co2 tank 20. The details of these resting locations will be described in more detail in FIGS. 3 and 4. Both the barrel and tank resting components are essentially open “U” shaped members that allow the barrel of the gun or the tank from the gun to be placed vertically into the gun rest. The barrel holding member 10 connects to the tubular structure with fastener 15 that provides retention of the holder to tube 30. This tube then bends 40 to attach to a horizontal joining tube 35. In this embodiment the tube is shown with a bend, but it is also contemplated that tube 30 joins tube 35 with a perpendicular fish mouth type connection. The tube 35 connects into the tank holding member 20 with a fastener 25. Fasteners 15 and 25 can be threaded fasteners, or any variety that allows members 10 and 20 to be held in the desired orientation. While threaded fasteners have been disclosed a variety of other fasteners are contemplated including welding bonding and interference fit type arrangements that do not allow the pieces to move. A vertical tubular member 50 connects to the bottom of tube 35. This vertical tube slides over the end of member 65 until it rests on a flat surface 62 on member 60 that is attached to horizontal tube member 70. The horizontal tube 70 is shown in sections with connection joints 72 showing where the horizontal tube members can be added or removed to allow for holding additional paintball guns.

Multiple sets of these studs including items 60, 62 and 65 are located along the top of tube 70. The studs allow for multiple paintball gun holders' to be placed onto tube 70. From this FIG. 3 sets of paintball gun holder's are shown, but a location for a fourth, is shown with the paintball gun holder 62. One of the unique attributes of this invention is the ability to increase the number of paintball gun holder's by simply adding more studs to tube or connecting multiple tubes 70 together and placing the paintball gun holder's on to the studs. Tube 70 extends horizontally and joins the end of member 75 that then connects to legs 80. The legs 80 are basically a set of sawhorse shaped legs that allows the entire assembly to be easily installed and removed from one location to another. Alternative methods for locating the paintball gun holding rack are shown and described in FIGS. 5 and 6. The legs 80 may be replaced with a single legs that can be driven into the ground by way of a mallet, hammer or by using the way to the person to press the leg into the ground. This and other configurations of legs allow the multiple paintball gun holder to be quickly set-up and taken down for easy transportation.

The invention shown is fabricated using tubes or tubular type construction, but other methods of fabricating the components are contemplated. The method of fabrication should include but not be limited to molding, forging, casting, welding, bending and machining. The materials used include but are limited to plastics, Ferris and nonferrous metals, fiberglass and wood.

Referring to FIG. 2, there is shown an isometric view of a single holder with a paintball gun 5 installed on the holder. This figure shows the barrel of the gun 2 being supported by the barrel holder 10. The fingers of the holder 11 are shown on opposite sides of the barrel of the paintball gun. The tank 4 of the paintball gun is shown in the tank holder 20 with vertical fingers 22 shown on the sides of the tank. Various different configurations of paintball guns are currently available, and the paintball gun holder disclosed accommodates a large variety of these different paintball guns. The paintball gun holder disclosed may also be adjustable to accommodate current and future configurations of paintball guns. These adjustments may allow for the vertical tube 30 to be extendable, as well as horizontal tube 35 and 37 to be extendable. These adjustments will allow accommodation of virtually any size and shape paintball gun.

Referring to FIG. 3 there is shown a front view of the barrel holding portion of the holder 10. This portion of the holder comprises a U-shaped holder with two vertical components 11A and 11B. The vertical components prevent the barrel of the gun from sliding out of the holder. The trough of the holder 18 is where the barrel of gun rests. Recess 12 provides a location for a felt or rubber pad to be placed that will provide a softer surface to reduce the possibility of scratching or damaging the barrel of the paintball gun. Recess 14 provides a location for a horizontal tube to be clamped. The hole 15 provides an attachment location for hardware such as a screw to hold the barrel rest on to the remainder of the holder.

Referring to FIG. 4 there is shown a front view of the tank holding portion of the holder 70. This portion of the holder comprises a U-shaped holder with two vertical components 22A and 22B. These vertical components prevent the tank of the gun from sliding out of the holder. The trough of the tank holder 22 is where the tank for the paintball gun is held. Recess 28 provides a location for a felt or rubber pad to be placed that will provide a softer surface to reduce the possibility of scratching or damaging the tank of the paintball gun. The whole 25 provides attachment location for hardware such as a screw to hold the tank holding portion of the paintball gun rest. The radius of the tank holder can also be adjusted to accommodate several different sizes of paintball tanks. It is also contemplated that the tank holder be field replaceable or adjustable to allow for different size paintball gun tanks. The adjustment may be with a spring, band or gravity adjustment to accommodate the various tanks.

In the preferred embodiment the paintball gun holder components 10 and 70 are made from a plastic resin. Other materials are contemplated including but not limited to wood machine plastic fiberglass and metals.

Referring to FIG. 5 there is shown an alternate isometric view of the paintball gun holder shown above a wall mountable adapter. The bottom tube section of the paintball holder can be placed onto a variety of holding components. In this figure the paintball gun holder is shown being brought down 110 on to a wall mountable fixture. The paintball gun holder is brought down over tube section 63 until it rests on horizontal surface 66. A fastener can be placed through whole 64 and whole 63 to keep the paintball gun holder for rotating. A horizontal brace 90 spaces the holder away from wall. The back portion of the wall-mounted holder 95 provides support and a mounting surface for the apparatus. Holes 97 are used for mounting the apparatus on to a wall rock or other vertical or near vertical surface. In this embodiment the vertical barrel holding portion is fish mouthed 42 onto the horizontal tube 38. Tube 38 is shown extending beyond the fish mouth connection. This extension of tube allows a user to hang goggles, clothing, tools or other devices in the same holder where they place their paintball gun.

Referring to FIG. 6 there is shown an alternate isometric view of the paintball gun holder shown above a table mountable adapter. This configuration is intended for mounting the paintball holder on a table or other flat surface. The lower portion of this figure shows a threaded clamped type mechanism. The bottom of the paintball gun holder is slid over to 65 and brought down onto the surface 68 of the clamp. Holes 64 and 67 allow for hardware such as screws or other fasteners to retain the paintball gun holder onto the clamping mechanism. Clamping pad 104 is moved by turning handle 102 to drive the pad 104 into the underside of a table to clamp the device and prevent it from moving.

FIGS. 5 and 6 show two alternate embodiments on how the paintball gun can be moved and mounted. These are just two alternative examples on how the paintball gun holder can be attached, but other embodiments that provide for similar mounting are possible. In another contemplated embodiment of the clamping mechanism, a spring loaded clamp is utilized to hold the mount onto a vertical, horizontal, or angular oriented surface.

Thus specific embodiments and applications for a paintball gun holder that can cradle multiple paintball guns, and can expand to accommodate additional paintball guns have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A free standing paintball run rack comprising:
a free standing structure having at least three elongated legs;
a horizontal connecting member that connects at least two the elongated legs to at least on one elongated leg wherein;
the horizontal connecting member includes a plurality of support members each having at least two support means for supporting a paintball gun.

2. The free standing paintball run rack from claim 1 wherein the free standing structure comprises at least four elongated legs where at least two legs are located on each side of the horizontal connecting member.

3. The free standing paintball run rack from claim 1 wherein the horizontal connecting member consists of one or a plurality of connecting members each having at least one support member for supporting a paint ball gun.

4. The free standing paintball run rack from claim 1 wherein the support member for supporting the paintball gun supporting means is oriented in a vertical, horizontal or angular orientation and maintain the paintball supporting means in essentially the same height above the ground.

5. The free standing paintball run rack from claim 1 wherein the supporting means for supporting a paintball gun comprises a concave or “V” shape for supporting the tank portion and or barrel of a paintball gun.

6. The free standing paintball run rack from claim 1 wherein the free standing elongated legs and or the horizontal connecting member(s) are made from a shaft or tubular material such as plastic, aluminum, wood or steel.

7. The free standing paintball run rack from claim 1 wherein the at least two supporting means for supporting a paintball gun includes a cushion.

8. An expandable paintball run rack comprising:
a ground resting structure supported on elongated legs located on opposite ends of a centrally located horizontal member where;
the length of the horizontal member can be changed by adding or removing horizontal sections wherein;
each horizontal section includes at least one support member having at least two support means for supporting a paintball gun.

9. The expandable paintball run rack from claim 8 wherein the horizontal member consists of one or a plurality of connecting members each having at least one support member for supporting a paint ball gun.

10. The expandable paintball run rack from claim 8 wherein the ground resting standing structure comprises at least four elongated legs where at least two legs are located on each side of the horizontal member.

11. The expandable paintball run rack from claim 8 wherein the support member for supporting the paintball gun supporting means is oriented in a vertical, horizontal or angular orientation and maintain the paintball supporting means in essentially the same height above the ground.

12. The expandable paintball run rack claim 8 wherein the supporting means for supporting a paintball gun comprises a concave or “V” shape for supporting the tank portion and or barrel of a paintball gun.

13. The expandable paintball run rack from claim 8 wherein the ground resting structure and or the horizontal member(s) are made from a shaft or tubular material such as plastic, aluminum, wood or steel.

14. The expandable paintball run rack from claim 8 wherein the at least two supporting means for supporting a paintball gun includes a cushion.

15. A paintball run rack with clamping mechanism comprising:
at least one support member having at least two support means for supporting at least one paintball gun wherein;
the support member includes a clamping mechanism for clamping the support member to a vertical, horizontal or angularly orientated structure allowing retention and removability of the support member and paintball gun supporting means.

16. The paintball run rack with clamping mechanism from claim 15 wherein the claming support allows the support member for the paintball gun to pivot, spin and or turn.

17. The paintball run rack with clamping mechanism from claim 15 wherein the clamp comprises a screw or spring that provides the clamping force.

18. The paintball run rack with clamping mechanism from claim 15 wherein the supporting means for supporting a paintball gun comprises a concave or “V” shape for supporting the tank portion and or barrel of a paintball gun.

19. The paintball run rack with clamping mechanism from claim 15 wherein the ground resting structure and or the horizontal member(s) are made from a shaft or tubular material such as plastic, aluminum, wood or steel.

20. The paintball run rack with clamping mechanism from claim 15 wherein the at least two support means for supporting a paintball gun includes a cushion.
